(19) United States
(12) Patent Application Publication
(10) Pub. No.: US 2011/0283697 A1
(43) Pub. Date: Nov. 24, 2011

(54) Exhaust gas turbocharger for an internal combustion engine

(76) Inventor: Torsten Hirth, Rutesheim (DE)

(21) Appl. No.: 13/136,170

(22) Filed: Jul. 26, 2011

Related U.S. Application Data
(63) Continuation-in-part of application No. PCT/EP2009/009083, filed on Dec. 17, 2009.

(30) Foreign Application Priority Data
Jan. 27, 2009 (DE) 10 2009 006 278.5

(51) Int. Cl. F02C 6/12

(52) U.S. Cl. 60/605.1

(57) ABSTRACT

In an exhaust gas turbocharger for an internal combustion engine having a turbine housing for receiving a turbine wheel, having a guide device having guide elements for influencing flow parameters in a turbine wheel inlet area, a displaceable adjusting device associated with the guide device, and also a contour sleeve element for influencing flow parameters in a turbine wheel outlet area, the guide device, the contour sleeve element, and the adjusting device are inserted as a subassembly into the exhaust gas turbocharger housing via the turbine outlet area and firmly mounted in the turbine housing.

This is a Continuation-In-Part application of pending international patent application PCT/E2009/009083 filed Dec. 17, 2009 and claiming the priority of German Patent application 10 2009 006 278.5 filed Jan. 27, 2009.

### BACKGROUND OF THE INVENTION

The invention relates to an exhaust gas turbocharger for an internal combustion engine having a turbine housing with a turbine wheel and an exhaust gas outlet and a flow guide device arranged in the turbine outlet.

Exhaust gas turbochargers for an internal combustion engine, having a turbine housing receiving a turbine wheel, having a guide device having guide elements for influencing flow parameters in a turbine wheel inlet area, having a displaceable adjusting device associated with the guide device, and having a contour sleeve element for influencing flow parameters in a turbine wheel outlet area are known. This means generally, that a centered guide grid is for example present on the bearing housing side of the exhaust gas turbocharger, where an effective cross-section of the guide grid can be changed with an axial slider, in that guide vanes of the guide element extend into a matrix of the axial slider. This guide grid represents the guide device with guide elements for influencing the flow parameters at the turbine wheel inlet area.

With the known solutions, this guide grid has to be pressed into the turbine housing through the bearing housing of the exhaust gas turbocharger and thus be fixed in the axial and radial direction. A rotation of the guide grids is also prevented in this manner. The axial slider is secured against rotation via the guide grid in that the guide vanes of the guide grid extend into the matrix of the axial slider, which adjusts the effective flow cross section of the guide grid.

In order to avoid cogging of the guide grid and the axial slider during operation of the exhaust gas turbocharger, a gap has to be provided over a long tolerance chain. This tolerance chain comprises the guide grid, the turbine housing, a contour sleeve and the axial slider. A possible contour deformation during an operation due to high temperature gradients and a force introduction into the turbine housing from the outside also has to be considered during the choice of a size of this functional gap. A larger functional gap always leads to lower efficiencies of the exhaust gas turbocharger, which increases fuel consumption of an internal combustion engine and CO₂ emissions.

With the guide grid fixed rigidly in the turbine wheel, the guide grid can only be assembled from a bearing housing side. In contrast to this, the axial slider and the contour sleeve element can only be assembled from the turbine outlet side, that is, in the axial direction from the opposite side of the bearing housing. This requires a two-sided assembly which results in an additional effort, which increases the assembly costs for the exhaust gas turbocharger and thus the total costs for a motor vehicle, where such an exhaust gas turbocharger is used. Additionally, this additional effort leads to possible error sources during the assembly of the exhaust gas turbocharger, whereby the failure risk is increased on the one hand and on the other hand, reworkings are possibly necessary, which also increase the assembly costs with all connected disadvantages.

It is the object of the present invention to provide an exhaust gas turbocharger of the type referred to above wherein assembly efforts and thus the assembly expenses are reduced.

### SUMMARY OF THE INVENTION

In an exhaust gas turbocharger for an internal combustion engine, having a turbine housing receiving a turbine wheel, and a guide grid having guide elements for influencing flow parameters in a turbine wheel inlet area, a displaceable adjusting device associated with the guide device, and also a contour sleeve element for influencing flow parameters in a turbine wheel outlet area, the guide device, the contour sleeve element, and the adjusting device are mounted as a subassembly in the exhaust gas turbocharger and are insertable into the turbine housing via the turbine outlet area.

This reduces an assembly effort of the turbocharger considerably on the one hand, whereby an assembly time can be reduced. This saving of assembly time results in a saving of assembly costs, which is directly transferred to a reduction of total costs of the exhaust gas turbocharger and thus of total costs of a motor vehicle where such an exhaust gas turbocharger is used.

Furthermore, assembly is simplified and possible error sources, for example, in the form of an erroneous assembly, are excluded or at least reduced, which largely eliminates elaborate and cost-intensive reworking needs. This fact also has a positive effect on the assembly costs and thus on the total costs of the motor vehicle. Furthermore, the tolerance chain mentioned with the description of the state of the art is reduced with the exhaust gas turbocharger according to the invention, whereby the function gap can also be reduced.

A smaller functional gap leads, as indicated, to a higher efficiency of the exhaust gas turbocharger, whereby a fuel use of an internal combustion engine, where such an exhaust gas turbocharger according to the invention is used, can be reduced. The reduction of the fuel consumption of the internal combustion engine also provides for a reduction in CO₂ emissions, which is beneficial o the environment.

In an advantageous embodiment of the invention, the subassembly of the guide device, contour sleeve element and adjusting device is assembled from a turbine wheel outlet side. The assembling from a turbine wheel outlet side or from a turbine housing outlet has the advantage that a relatively large space for an assembly is available from this direction, which further reduces the assembly effort. This reduction of the assembly effort accompanies, as already described, a reduction of the assembly costs and thus a reduction of the total costs of the exhaust gas turbocharger and thus of the motor vehicle, in which such an exhaust gas turbocharger is used.

An increase of space available for the assembly also reduces the risk of an erroneous assembly, whereby the assembly costs are decreased further due to avoiding reworkings on the one hand, a failure risk of the exhaust gas turbocharger during an operation of the exhaust gas turbocharger is reduced on the other hand, which means a comfort gain for a driver of the motor vehicle with such an exhaust gas turbocharger, as repair intervals or work shop intervals can be increased. A more simple and thus more precise assembly of the exhaust gas turbocharger in the described manner also ensures the functionality of the exhaust gas turbocharger, that is, erroneous functions are avoided, which could possibly lead to an increased fuel use and thus to increased CO₂ emissions. This is avoided or highly reduced by the exhaust gas turbocharger according to the invention.

In one embodiment of the invention, the adjusting device is formed as an axial slide member adjustable in the direction of a rotational axis of the turbine wheel, by means of which the guide element can be at least partially enclosed. This means that the adjusting device is an axial slider having a housing which can accommodate for example blades of the flow guide device. It is noted here that other forms of adjusting devices and/or flow guide devices can also be used in connection with the exhaust gas turbocharger according to the invention.

From the description of the embodiment, it is apparent that an ease of the assembly and thus a reduction of the failure probability of the exhaust gas turbocharger is particularly advantageous with an adjusting device or guide structure described since the flow guide device and the adjusting device contribute highly to a more efficient operation of the exhaust gas turbocharger. In this respect, an error-free and precise operation of this flow guide device or this adjusting device is necessary, in order to for example keep the fuel use consumption of the internal combustion engine and thus CO₂ emissions low.

The precise mechanism of the adjusting device in the form of an axial slider that can be adjusted in the direction of a rotational axis of the turbine wheel, by means of which the flow guide device can be enclosed at least partially, requires a precise, error-free and virtually tolerance-free assembly, which is enabled by the exhaust gas turbocharger according to the invention. As already described, the assembly effort and the failure risk of the flow guide device or of the adjusting device are thereby reduces, which reduced the assembly costs and the fuel consumption of the internal combustion engine due to a smaller function gap.

With an advantageous embodiment of the invention, the guide device is centered in the turbine housing by means of a centering device, particularly a collar. A precise alignment of the guide device is ensured via this radial centering, whereby a function of the exhaust gas turbocharger during operation is optimized. This increases an efficiency of the turbocharger and thereby reduces the fuel consumption of the internal combustion engine, where an exhaust gas turbocharger according to the invention is used. This accompanies a reduction of CO₂ emissions and thus a protection of the environment.

For preventing an axial movement of the flow guide device, the flow guide device is preferably fixed in the turbine housing by means of a securing element, particularly a securing ring. The flow guide device is thereby fixed in its axial position, whereby the function of the flow guide structure and thus the function of the entire exhaust gas turbocharger is further influenced in a positive manner. This results, as already described above, in an improvement of the efficiency during the operation of the exhaust gas turbocharger, which accompanies a reduction of the fuel consumption of the internal combustion engine

In a particularly advantageous embodiment of the invention, the flow guide device is fixed in the turbine housing in the radial direction by means of a collar. This means that the flow guide device is centered radially on the one hand by means of the collar, which results as described in an optimum alignment and thus an optimum function, on the other hand, the collar takes on the securing of the flow guide device in the axial direction with this embodiment of the invention. An additional securing element for example in the form of a securing ring can thus be foregone. It can thereby be provided that the collar is engaged with its positive form into a corresponding negative counter contour in the turbine housing. The omission of an additional securing element reduces production costs of the exhaust gas turbocharger, whereby the total costs of the motor vehicle are influenced in a positive manner.

The avoidance of an additional securing ring further represents also a reduction of a total weight of the exhaust gas turbocharger, which results in a reduction of the total weight of the motor vehicle, whereby a lowering of the fuel consumption of the motor vehicle is also achieved. This provides for lower CO₂ emissions, on one hand, and also lower operating costs for the driver of the motor vehicle.

As has already been indicated, the collar of the guide device is latched or engaged in a corresponding counter contour in the turbine housing for the axial fixing of the guide device. This is for example possible in that the guide device can be pressed together in the radial direction due to a certain elasticity of a material of which the guide device is formed. The guide device can then be inserted into the turbine housing in the pressed state, and latched therein. By this fact, elaborate and complex special tools for the assembly are avoided, which further influences the assembly costs in a positive manner with all advantages already described in this connection and possibly further advantages. It is also possible that the turbine housing has the positive collar form and the guide device the negative counter contour. The advantages described in this connection remain the same.

In an advantageous embodiment of the invention, the guide device is formed as a guide grid, which has a plurality of blade elements and a ring element for receiving the blade elements.

By means of this design, the flow parameters in the turbine wheel inlet region can be influenced in a particularly favorable manner, namely in that the flow parameters can be adjusted optimally to an operating point of the exhaust gas turbocharger or to an operating point of the internal combustion engine, where such an exhaust gas turbocharger is used. Efficiency-optimum operations of the exhaust gas turbocharger are made possible thereby. Fuel consumption and thus CO₂ emissions can be substantially reduced.

The more precise this flow guide device is, and the more precisely it can be adjusted by means of an adjusting device for influencing the flow parameters, the more optimally the operating point of the internal combustion engine can be adjusted. The advantage of the fuel reduction can be realized in a particularly good manner. Exactly in connection with this precise embodiment of the guide device and/or the adjusting device, an exhaust gas turbocharger according to the invention is advantageous in that a precise and error-free assembly is necessary exactly in this case, in order to avoid error functions and thus an increased fuel use or even a failure of the exhaust gas turbocharger.

If the guide device comprises several parts in a particularly advantageous embodiment of the invention, costs for the guide device can be lowered. The reason for this is that such a guide device, particularly in the form of a flow guide structure, can only be manufactured as a fine cast part in the form of a one-part design, in particular if a series production with a large number of pieces is provided. Casting tolerances of the guide device which especially in the form of a flow guide vane structure has several guide vanes, should be as low as possible in order to keep a function gap between the guide device and the adjusting device, that is, concretely between the flow guide structure and the axial slider, as low as possible, in order to be able to realize an efficiency-optimum operation of the exhaust gas turbocharger. In this connection, a form of the guide elements or of the guide blades of the flow guide device and their position to each other is especially relevant. These high requirements of to precision of the guide device lead to very high costs in addition to a size of the guide device which is represented as a fine cast part.

In the present case, a multi-part design of the flow guide vane structure and particularly of the flow guide vane structure replaces the one-part component, which is cost-intensive with regard to size and tolerance requirements. Production costs of the guide device and thus the total costs of the exhaust gas turbocharger are thereby reduced further, which also has a positive effect on a reduction of the total costs of the motor vehicle, where an exhaust gas turbocharger according to the invention is used.

Nevertheless, a precise assembly is achieved despite the multi-part design, due to the described assembly of the subassembly of the guide device, the contour sleeve element and the adjusting device. By means of this embodiment, all advantages of an exhaust gas turbocharger regarding a simple assembly and thus a reduction of the assembly costs are combined with all advantages of a precise functionality and a reduction of the failure probability.

It is advantageous with the multipart guide device that the guide elements of the guide device are fixed in the axial direction of the exhaust gas turbocharger respectively by means of a collar. The axial fixing of the guide elements by means of a collar facilitates a simple and non-elaborate fixing thereof, whereby, as indicated, the assembly effort and thus the assembly costs are kept low. Nevertheless, a precise alignment of the flow guide elements is achieved, which enables an efficiency-optimum operation of the guide device and therewith of the entire exhaust gas turbocharger.

The precise alignment and thus the precise efficiency optimum function of the exhaust gas turbocharger is increased further with an advantageous embodiment of the invention in that the collar is on the one hand in contact with a corresponding surface of a guide structure receiving the guide elements and on the other hand with a corresponding surface of a heat shield of the exhaust gas turbocharger. By means of this fact, a defined positioning of the guide elements is obtained, from which they cannot move, even with a high strain on the exhaust gas turbocharger. A simple assembly is nonetheless facilitated, as additional fixing elements for example in the form of screws and/or rivets are unnecessary. The flow guide elements are for example stuck together or stuck into a reception element, for example into the ring element of the flow guide device in a simple manner and are fixed in their position in the described manner. This simple assembly offers little play for assembly errors, which avoids elaborate reworkings in the case of an erroneous assembly. The failure probability is also reduced by this simple assembly, whereby repair intervals can be increased, which is beneficial for the driver of the motor vehicle with such an exhaust gas turbocharger.

The flow guide device does not necessarily have to have the form of a guide grid with guide elements or guide blades. Other guide devices and also other adjusting devices than an axial slider are possible in connection with the exhaust gas turbocharger according to the invention. It is crucial that the subassembly of the guide device, adjusting device and contour sleeve element is simply assembled as a component module or a cassette in the exhaust gas turbocharger according to the invention, whereby assembly and total costs of the exhaust gas turbocharger are reduced on the one hand and a failure probability is lowered on the other hand due to the more simple assembly.

With an advantageous embodiment of the invention, the contour sleeve element has a small diameter and a large diameter part, wherein the adjusting device is guided only by means of the small diameter and possibly by means of a pin. In this manner a safe and precise guide of the adjusting device can be realized on the one hand, and on the other hand, a double fitting is avoided, as there is no direct contact of the contour sleeve element on two diameters of different size. This results in an avoidance of a high manufacturing effort and thus high manufacturing costs.

It can advantageously be provided that a sealing function is realized by means of the large diameter, whereby the subassembly is sealed with regard to the turbine housing. A discharge of exhaust gas into the turbine housing and consequently into the environment is prevented thereby.

Further advantages, characteristics and details of the invention will become apparent from the following descriptions of exemplary embodiments with reference to the accompanying drawings. The characteristics and characteristics combinations mentioned previously in the drawings and the characteristics and characteristics combinations mentioned in the following in the figure description and/or shown alone in the figures cannot only be used in the respectively given combination, but also in other combinations or on their own without leaving the scope of the invention.

### BRIEF DESCRIPTION OF THE DRAWINGS

FIG. 1A is a perspective view and a longitudinal section view of a subassembly of an axial slider and a contour sleeve for an exhaust gas turbocharger,

FIG. 1B shows the axial slide with contour sleeve in cross-section,

FIG. 2A is a perspective view of the subassembly according to FIG. 1 of the axial slider and the contour sleeve, wherein the subassembly is extended by a flow guide grid,

FIG. 2B is a longitudinal cross-section view of the subassembly of FIG. 2A in sections, mounted in a turbine housing of an exhaust gas turbocharger.

FIG. 3A is a perspective view of a multi-part guide grid with a guide blade support ring and a plurality of guide blades,

FIG. 3B shows the guide blade support ring

FIGS. 4A and 4B show two longitudinal sectional views sections through different planes of a turbine housing of an exhaust gas turbocharger, in which the subassembly according to FIG. 2A is mounted, wherein the one-part flow guide grid according to FIG. 2A is replaced by the multi-part flow guide grid according to FIG. 3A and wherein this guide grid in FIGS. 4A and B are disposed in the turbine housing in a form different from FIGS. 2A, 2B and

FIG. 5 is a perspective view of the subassembly according to FIGS. 2A and 2B, wherein in FIG. 5, as in FIGS. 4A and 4B, the one-part guide grid is replaced by the multi-part guide grid according to FIG. 3.

### DESCRIPTION OF PARTICULAR EMBODIMENTS

In the description, the same reference numerals are used to refer to the same elements.

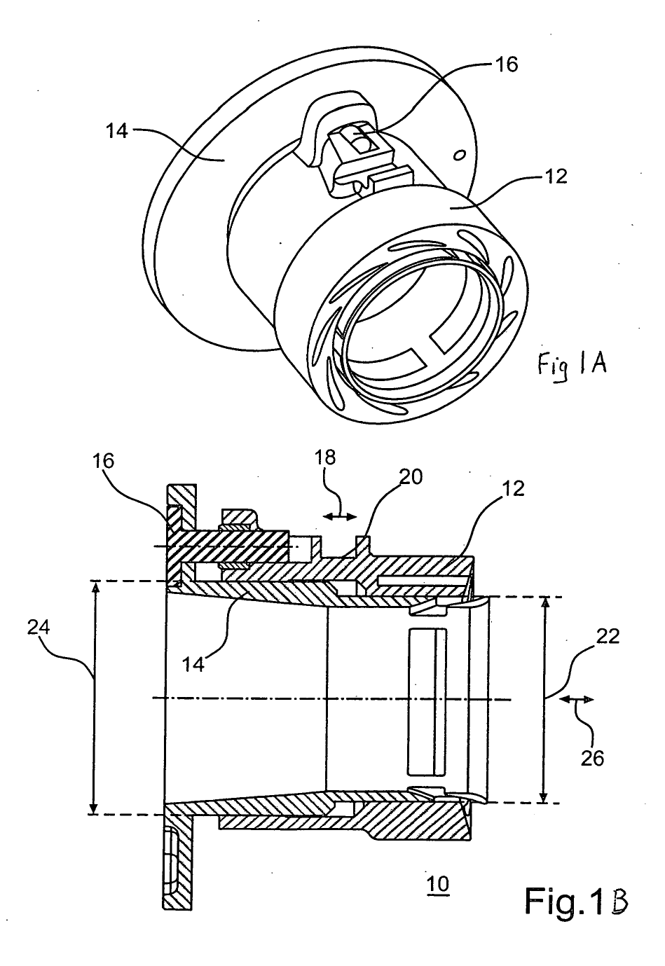

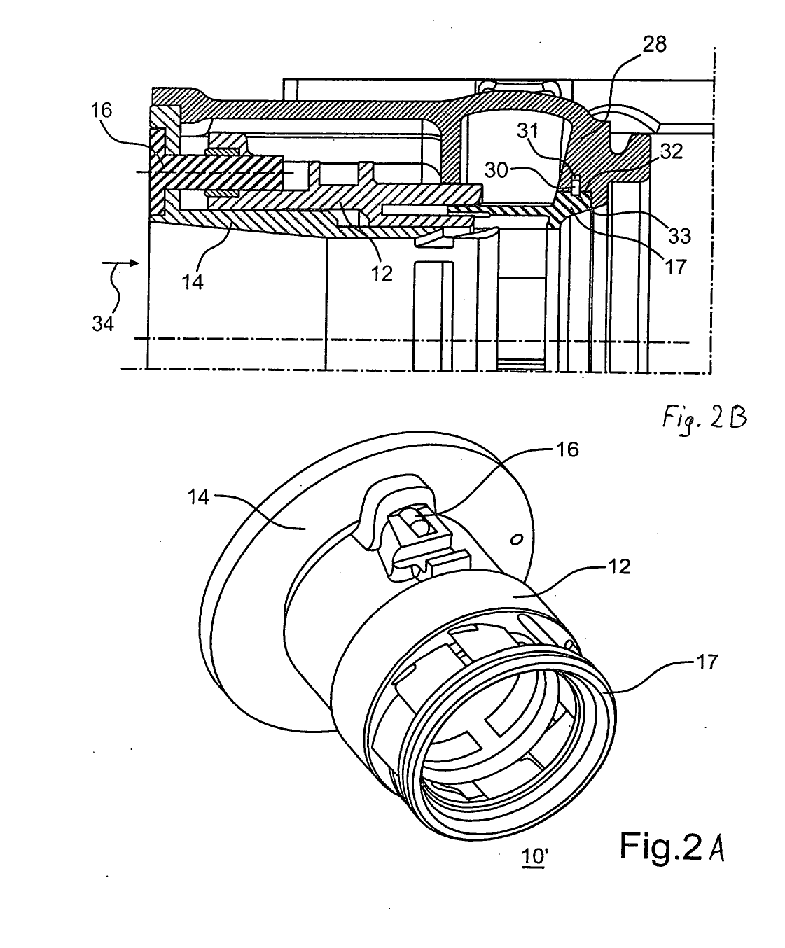

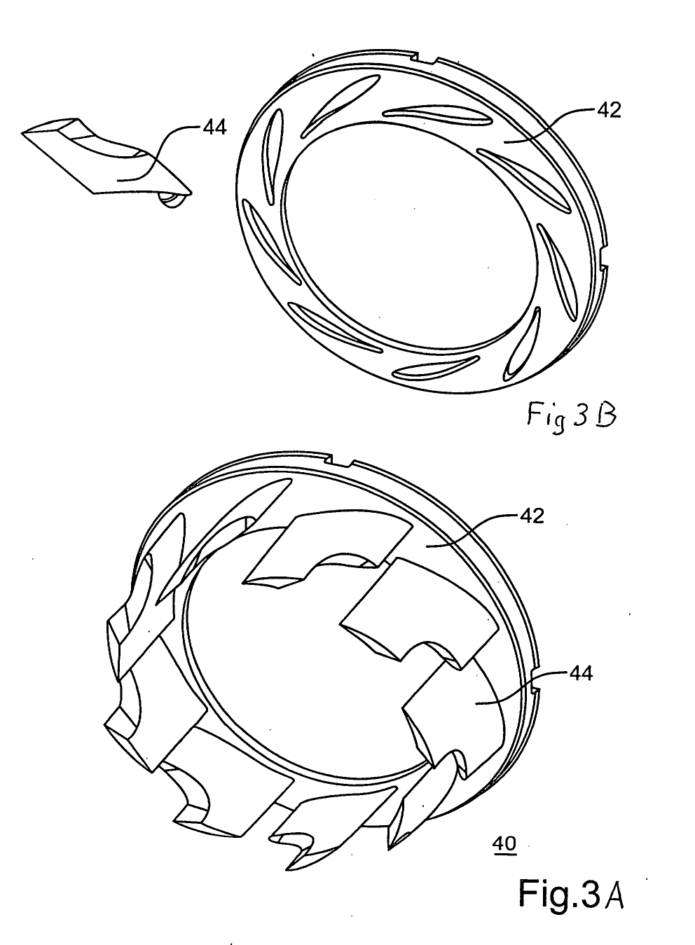

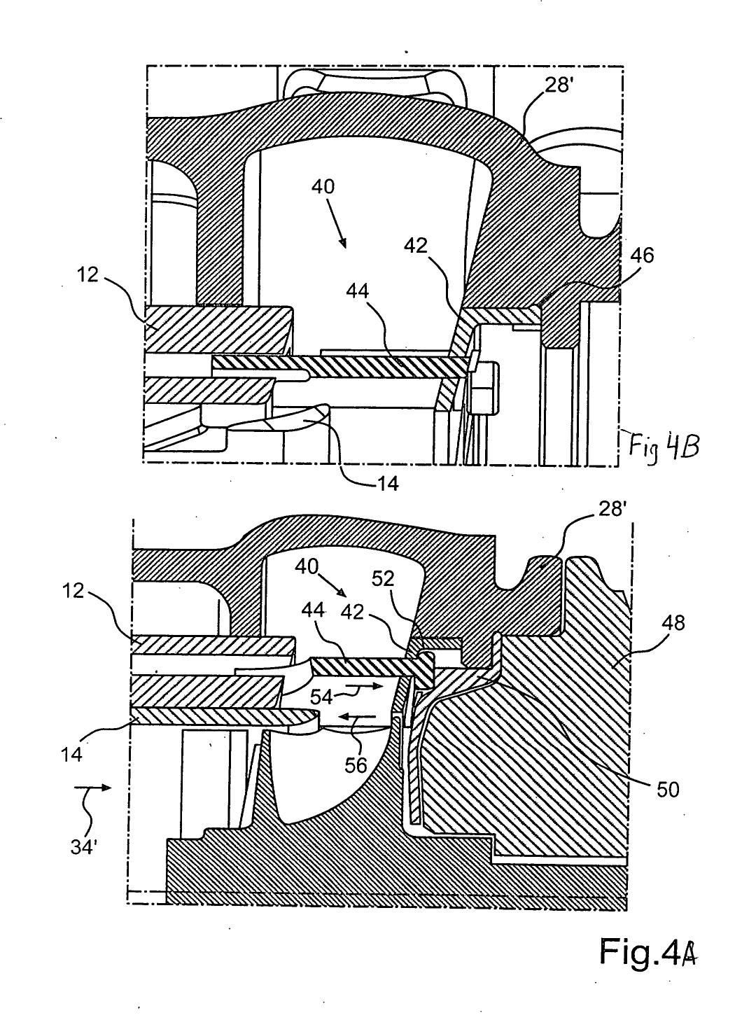

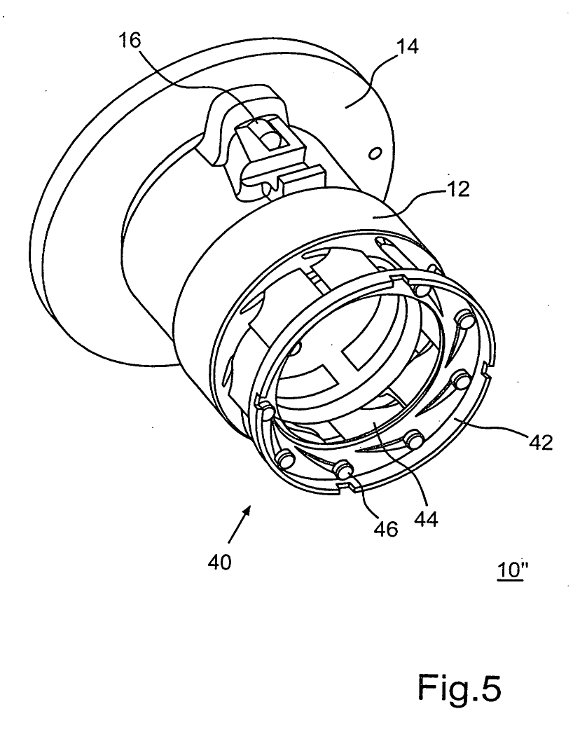

While FIG. 1 shows a subassembly of an axial slider for adjusting flow parameters in a turbine wheel inlet area and a contour sleeve for influencing flow parameters in a turbine wheel outlet area, this subassembly of FIG. 1 includes in FIGS. 2A and 2B a one-part guide grid having a plurality of guide blades, which extend into a guide blade support structure or mold of the axial slider, and an assembly of this subassembly in a turbine housing of the exhaust gas turbocharger. FIGS. 3A and 3B shows a possible embodiment of a multi-part guide grid with a guide blade mold and a plurality of guide blades. FIG. 4A and FIG. 4B show an assembly of the subassembly according to FIG. 2A and FIG. 2B, wherein the one-part guide grid is replaced by the multi-part guide grid shown in FIG. 3A, wherein a fixing of the multi-part guide grid in the turbine housing takes place in a manner different from the one of the one-part guide grid shown in FIGS. 2A, 2B. FIG. 5 shows the subassembly of the axial slider, the contour sleeve and the multi-part guide grid in a perspective view.

FIGS. 1A and 1B shows the subassembly 10, which has an axial slider 12 and a contour sleeve 14. A pressure backup behavior of a turbine of an exhaust gas turbocharger, where such a subassembly 10 is used, can be varied by means of the axial slider 12.

The axial slider 12 is guided on a small diameter 22 of the contour sleeve 14 and on a pin 16. A large diameter 24 of the contour sleeve 14 only has a sealing function, direct contact with the contour sleeve 14 is not possible. An adjustment force 18 is introduced directly into the axial slider 12 via an adjusting intervention 20. Thereby, a device, not shown, engages the adjusting recess 20. This device can for example be adjusted in a regulated manner by means of an actuator. With the subassembly shown in FIG. 1, the axial slider 12 can only be moved in the axial direction 26. A rotation of the axial slider 12 relative to the contour sleeve 14 is not possible. In and assembled state of the subassembly 10 it is provided that the contour sleeve 14 is mounted in a turbine housing of the exhaust gas turbocharger in a fixed manner.

FIG. 2A shows a subassembly 10′, which is extended by a one-part guide grid 17 compared to the subassembly 10 of FIG. 1B. The subassembly 10′ in FIG. 2A comprises the axial slider 12, the contour sleeve 14 and the one-part guide grid 17. For the guide of the axial slider 12, the same applies as already described in connection with FIGS. 1A, 1B. An axial slider 12 secured against rotation via the contour sleeve 14 offers the possibility that a guide grid 17 rigidly connected to the turbine housing 28 is not necessary. The guide grid 17 only has to be fixed in the axial and the radial direction in the turbine housing 28. A rotation of the guide grid 17 is prevented by the axial slider 12.

The guide grid is thereby centered radially via the turbine housing 28, namely by means of a collar 32. A securing ring 30 serves for preventing a movement of the guide grid 17 in the axial direction. The securing ring 30 is arranged in a groove 31 of the turbine housing 28. In an assembled state, the securing ring 30 also engages a corresponding groove 33 of the one-part guide grid 17. The one-part guide grid 17 is thus also fixed in its axial position.

With this embodiment it is possible that the subassembly 10′ consisting of the axial slider 12, the contour sleeve 14 and the one-part guide grid together with the pin can be inserted as a unit into the turbine housing 28 from a turbine outlet side 34. The subassembly 10′, which can also be called cassette, can already be assembled prior to the final assembly in this manner. This modularity saves assembly time, which lowers the assembly costs. A risk of an erroneous assembly is also lowered, whereby cost-intensive reworking can be avoided, and a failure probability of the exhaust gas turbocharger during an operation thereof is reduced.

FIG. 3A shows a multi-part guide grid 40, which has a guide blade mold 42, at which a plurality of guide blades 44 can be arranged. Such a multi-part guide grid 40 can replace the one-part guide grid 17 according to FIG. 2A, 2B, which is quite cost-intensive with regard to a component size and with regard to tolerance requirements. These guide grids are usually produced by means of a fine casting method, in order to fulfill the mentioned high tolerance requirements.

In FIGS. 4A, 4B is assembled subassembly is shown mounted in the turbine housing 28′, similar to the subassembly 10′ according to FIG. 2A, wherein the subassembly in FIG. 4 is distinguished from the subassembly 10′ in FIG. 2A in that the one-part guide grid 17 is now replaced by the multi-part guide grid 40 according to FIG. 3A, 3B. The subassembly in FIG. 4A thereby consists of the axial slider 12, the contour sleeve 14 and the multi-part guide grid 40, which has, as described, a guide blade mold 42 and a plurality of blade elements 44.

The guide blade mold 42 is centered in the turbine housing 28′. A collar 46 at the guide blade mold 42 serves for fixing the guide blade mold 42 in the axial direction, which is latched into a corresponding counter contour in the turbine housing 28′. The turbine housing 28′ in FIGS. 4A, 4B is different from the turbine housing 28 in FIG. 2B at this location, as in FIG. 2B a fixing of the guide grid 17 which is in one part there, is realized by means of a collar 32 and a securing ring 30.

The guide vane mold 42 of the subassembly in FIG. 4A, 4B is fixed by the collar 46 in the radial and the axial direction. The assembly can for example take place in that the guide vane mold 42 is pressed together slightly in the radial direction and is inserted into the turbine housing 28′. The individual guide blades 44 of the guide grid 40 are fixed axially by means of a collar 52. For fixing the guide blades 44 in the direction of a turbine outlet, as indicated by the direction arrow 54, a surface of the collar 52 is in contact with a corresponding surface of the guide vane mold 42. This prevents an axial movement of the guide blades 44 in the direction of the turbine outlet 54. In the opposite direction, which is indicated by a direction arrow 56, that is in the direction of a bearing housing 10, the axial movement of the guide blades 44 is prevented in that another surface of the collar 52 is in contact with a corresponding surface of a heat shield 50.

By means of the described two contacts of the collar 52, on the one hand with the guide blade mold 42 and on the other hand with the heat shield 50, the guide blades 44 of the guide grid 40 are thus fixed in their axial direction. In the radial direction, the guide blades 44 are fixed by a contour of the guide blade mold 42, into which the guide blades 44 extend in the described manner during the assembly of the multi-part guide grid 40.

It is also possible with an arrangement shown in FIG. 4A, 4B that the subassembly of the axial slider 12, the contour sleeve 14 and the multi-part guide grid and even possibly with the pin 16 as a unit can be pushed into the turbine housing 28′ or introduced therein from a turbine outlet side 34′. This subassembly can thus already be assembled prior to a final assembly of a turbocharger, where such a subassembly is used, which, as already described in connection with FIG. 2, low-ers an assembly effort and thus assembly costs, and also reduces a failure probability of the exhaust gas turbocharger.

FIG. 5 shows a subassembly 10″ as mounted in the turbine housing 28′ according to FIG. 4A, 4B. As can be seen in comparison to FIG. 2, the multi-part guide grid 40 is now arranged with the subassembly 10″, which grid has the guide vane mold 42, in which the guide plates 44 are received. The fixing in an axial direction of the guide blades 44 by means of the collar 46 can be seen particularly well in FIG. 5, which is in contact with a corresponding surface of the guide vane mold 42. The subassembly 10″ further has the elements already known from FIGS. 2A, 2B in the form of the axial slider 12, the contour sleeve 14 and the pin 16. As has already been described, this subassembly 10″ can also be mounted into a turbine housing of an exhaust gas turbocharger as one unit or a cassette, whereby an assembly effort and thus assembly costs can be lowered, and a failure probability of the exhaust gas turbocharger can be reduced.

What is claimed is:

1. An exhaust gas turbocharger for an internal combustion engine including a turbine housing (28) for receiving a turbine wheel, a flow guide device (17) with guide elements (44) arranged in the turbine housing for influencing flow parameters in a turbine wheel inlet area, a movable adjusting device (12) associated with the guide device (40), and a contour sleeve element (14) for influencing flow parameters in a turbine wheel outlet area, the flow guide device (17), the contour sleeve element (14), and the adjusting device (12) being in the form of a subassembly (10′) installed as a pre-assembled component in the turbine housing (28).

2. The exhaust gas turbocharger according to claim 1, wherein the subassembly (10′) is installed from a turbine outlet end (34).

3. The exhaust gas turbocharger according to claim 1, wherein the adjusting device (12) is formed as an axial slider (12) adjustable in the direction of a rotational axis of the turbine wheel, by means of which the flow guide device (17) can be enclosed at least partially.

4. The exhaust gas turbocharger according to claim 1, wherein the flow guide device (17) is centered in the turbine housing (28) by means of a centering device, particularly a collar (32).

5. The exhaust gas turbocharger according to claim 1, wherein the flow guide device (17) is fixed in the turbine housing (28) by means of a securing ring (30).

6. The exhaust gas turbocharger according to claim 1, wherein the guide device (40) is fixed axially in the turbine housing (28′) by means of a collar (46).

7. The exhaust gas turbocharger according to claim 6, wherein the collar (46) is latched into a corresponding counter contour.

8. The exhaust gas turbocharger according to claim 1, wherein the flow guide device (17) is in the form of a guide grid (17), which has a plurality of vane elements (44) and an annular element (42) for receiving the vane elements (44).

9. The exhaust gas turbocharger according to claim 1, wherein the flow guide device (17) comprises several parts.

10. The exhaust gas turbocharger according to claim 9, wherein the vane elements (44) of the guide device (40) are fixed in the axial direction of the exhaust gas turbocharger respectively by means of a collar (52).

11. The exhaust gas turbocharger according to claim 10, wherein the collar (52) is on the one hand in contact with a corresponding surface of a guide matrix (42) receiving the vane elements (44) and on the other hand with a corresponding surface of a heat shield (50) of the exhaust gas turbocharger.

12. The exhaust gas turbocharger according to claim 1, wherein the contour sleeve element (14) has a small diameter area (22) and a large diameter area (24), and the adjusting device is guided only by means of at least one of the small diameter area (22) and a pin (16).

13. The exhaust gas turbocharger according to claim 12, wherein the subassembly (10′) is sealed by means of the large diameter area (24).
